(19) United States
(12) Patent Application Publication
(10) Pub. No.: US 2010/0219539 A1
(43) Pub. Date: Sep. 2, 2010

(54) NEGATIVE ION LIQUID MANUFACTURING APPARATUS

(75) Inventors: Kouichi Harada, Hyogo (JP); Mitsuo Kimura, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: DAIICHITECHNO CO., LTD., Hashima-shi, Gifu (JP)

(21) Appl. No.: 12/600,089

(22) PCT Filed: May 14, 2008
(86) PCT No.: PCT/JP2008/058887

§ 371 Date: Nov. 13, 2009

(30) Foreign Application Priority Data
May 15, 2007 (JP) 2007-129032

(51) Int. Cl. B01F 3/04; B01F 1/00

(52) U.S. Cl. 261/86; 261/84

(57) ABSTRACT

Intended is to provide an apparatus, which is small in size and low at cost and which can manufacture a minus-ion generating liquid in a large quantity stably and continuously by a method safer than that of the prior art. In the apparatus, a single-stage reproducing pump comprises a casing having a suction port for sucking a liquid and a discharge port for discharging the liquid sucked from the suction port, an impeller disposed in the casing and forming a multiplicity of blades on the circumference of its disc, and a passage formed in the casing along the outer circumference of that impeller for guiding the liquid sucked from the suction port, to the discharge port. The area normal to the liquid flow direction of the passage becomes narrower from the suction port side to the discharge port side. The single-stage reproducing pump further comprises gas inflow means for feeding hydrogen and oxygen into a pressure liquid midway of the passage, in which the pressure of the liquid is gradually boosted from the suction port side to the discharge port side.

### FIELD OF THE INVENTION

The present invention relates generally to negative ion generation, and more particularly to an apparatus for manufacturing a useful liquid for generating negative ions.

### BACKGROUND ART

A negative ion is generally thought of as a charged atom or molecule (i.e., an “ion”) that carries a negative charge. For example, the areas in the vicinity of a waterfall or forest have an atmosphere with a high concentration of negative ions, and such high concentrations of negative ions, to which are attributed beneficial effects such as improving physiological functions and promoting emotional stability in humans, are thought not only to beneficially affect humans, but to have a positive effect on plant and animal life as well. Owing to the increase in health consciousness seen in recent years, a variety of man-made negative ion generators have been devised, and commercial household electronics and appliances equipped with a negative ion generator function are readily available on the open market.

There are three basic methods for artificially generating of negative ions: first, the water droplet fission method; second, the corona discharge method; and third, the radioactive material method. Refer to Non-patent Reference Document 1 for more detailed information on the aforementioned three methods. The water droplet fission method is a method that uses a property of water sometimes referred to as the Lenard effect, whereby when a jet stream of water collides with a flat surface or the like and is scattered into droplets, the large water droplets carry a positive charge and the small water droplets a negative charge. The corona discharge method is a method, also called the pulse discharge method, is a method that for generating negative ions by bombarding a gaseous body with an electric voltage. The radioactive material method is a method for causing the ionization of a gaseous body by bombarding the gaseous body with the radiation emitted from certain types of minerals, and is widely used in household electrical appliances such as dryers, air conditioners, and so on.

Non-patent Reference Document 1: “All About Ions”, Newton April 2007, Issue 4, p. 2-63, Newton Press, Inc., Apr. 7, 2007.

### SUMMARY OF THE INVENTION

However, problems have been pointed out in each of the above-described methods for artificially generating negative ions. That is to say: the water droplet fission method has a problem in that if to the cleanliness of the water is not maintained and microbes are propagated in the water, the microbes are also dispersed when the negative ions are released, easily adhering to the droplets of water and entering the human body; the corona discharge method has a problem in that ozone is generated along with the negative ions as a by-product, and the thus generated ozone may adversely affect on the human body when it is absorbed into the atmosphere; and the radioactive material method has a problem in that the radioactive material employed cannot be caused to emit radiation only below a certain value, but constantly emits a small amount of radiation. Refer to Non-patent Reference Document 1 for more information on the above-described problems.

However, with the establishment in Japan by the Japanese Industrial Standards organization of a standard for directly evaluating the concentration of ions in the air generated by a clean room ion generator, entitled the “Standard for measuring methods of airborne ion density”, on Nov. 20, 2006, it can be imagined that more efficient and safe negative ion generating methods will be developed one after the other.

On the other hand, in the course of carrying out research and development utilizing a patented “Vapor and liquid mixing apparatus”, which is an invention for which the patent is held by the inventor of the present invention, described in Japanese Patent No. 3058595, when a liquid that generates a plurality of minute bubbles while in a low-pressure state is obtained by having a gas dissolved and dispersed in the liquid under high pressure utilizing the aforementioned patented invention, we have found a way of making the oxidation-reduction potential (ORP) of the thus obtained liquid extremely low, and the capacity for the thus obtained liquid to generate a large amount of negative ions.

It is therefore an object of the present invention to provide an apparatus, which is compact in size and can be produced at low cost, capable of manufacturing a large volume of liquid that generates negative ions by a safer method than that taught by the prior art.

That is to say, the negative ion generating liquid manufacturing apparatus according to a first aspect of the present invention is equipped with a single-stage pump which is provided with a casing having an inlet port for drawing in a liquid and an outlet port for discharging the liquid drawn in from the inlet port, an impeller disposed within the casing, and a flow channel for guiding the liquid drawn in from the inlet port to the outlet port and of which the right-angle cross-sectional area in respect of the flow direction of the liquid flowing through the flow channel becomes steadily narrower progressing from the inlet port to the outlet port; being further equipped with a gas introducing means for sending hydrogen and oxygen into the liquid flowing through the flow channel, the pressure of the liquid flowing through the flow channel steadily increasing as it flows from the inlet port side of the flow channel to the outlet port side of the flow channel, from a point along the flow channel, in which, the liquid discharged from the outlet port is a liquid for generating negative ions in which hydrogen and oxygen have been dissolved or minute gas bubbles of hydrogen and oxygen dispersed.

Here, the hydrogen and oxygen to be injected into the flow of pressurized liquid by the gas introducing means can be provided in the form of a gas mixture of hydrogen and oxygen, or separately as hydrogen gas and oxygen gas. Note however, that the ninth aspect of the present invention described below presumes the use of a gas mixture of hydrogen and oxygen. Further, a variety of types of liquids can be used as the liquid to be drawn in at the inlet port and discharged from the outlet port.

The negative ion liquid manufacturing apparatus according to a second aspect of the present invention is equipped with a single-stage pump which is provided with a casing having an inlet port and an outlet port for discharging the liquid that has been drawn in from the inlet port, an impeller disposed within the casing, and a flow channel leading from the inlet port to the outlet port for guiding the liquid drawn in from the inlet port to the outlet port; being further equipped with a narrow bottleneck portion having a right-angle cross-sectional area that is narrow in respect of the flow direction of the liquid flowing through the flow channel, a gas introducing means for sending hydrogen and oxygen into pressurized liquid flowing through the flow channel at a point along said flow channel closer to the inlet port than the bottleneck portion, in which, the liquid discharged from the outlet port is a liquid for generating negative ions in which hydrogen and oxygen have been dissolved or minute gas bubbles of hydrogen and oxygen dispersed.

The negative ion generating liquid manufacturing apparatus according to a third aspect of the present invention is equipped with a single-stage regenerative pump provided with a casing having an inlet port for drawing in a liquid and an outlet port for discharging the liquid drawn in from the inlet port, an impeller provided with a discoid plate having formed on the peripheral portion thereof a plurality of blades and which is disposed within the casing, and a flow channel formed in the casing along the periphery of the impeller for guiding the liquid drawn in from the inlet port to the outlet port and of which the right-angle cross-sectional area in respect of the flow direction of the liquid flowing therethrough becomes steadily narrower progressively from the inlet port to the outlet port; being further equipped with a gas introducing means for sending hydrogen and oxygen into the pressurized liquid flowing through the flow channel, the pressure of the liquid flowing through the flow channel steadily increasing as the liquid flows from the inlet port side of the flow channel to the outlet port side of the flow channel, from a point along the flow channel, in which, the liquid discharged from the liquid outlet port is a liquid for generating negative ions in which hydrogen and oxygen have been dissolved or minute gas bubbles of hydrogen and oxygen dispersed.

The negative ion generating liquid manufacturing apparatus according to a fourth aspect of the present invention is equipped with a single-stage centrifugal pump provided with a casing, an impeller disposed within the casing, an inlet port disposed on the casing for drawing in a liquid and guiding the drawn in liquid to the center portion of the impeller, an outlet port disposed on the casing for discharging the liquid that has been drawn in from the inlet port, and a flow channel formed spanning from the center portion of the impeller to the peripheral portion of the impeller for guiding the flow of liquid drawn in from the inlet port to the outlet port and of which the right-angle cross-sectional area becomes progressively narrower from the center portion of the impeller toward the peripheral portion of the impeller; being further equipped with a gas introducing means for sending hydrogen and oxygen from a point along the flow channel into the pressurized liquid flowing through the flow channel, the pressure of the liquid flowing through the flow channel steadily increasing as the liquid flows from the center portion of the impeller to the peripheral of the impeller, in which, the liquid discharged from the outlet port is a liquid for generating negative ions in which hydrogen and oxygen have been dissolved or minute gas bubbles of hydrogen and oxygen dispersed.

The negative ion generating liquid manufacturing apparatus according to a fifth aspect of the present invention is equipped with a single-stage centrifugal pump which is provided with a casing, an impeller disposed within the casing, an inlet port disposed on the casing for drawing in a liquid and guiding the thus drawn in liquid to the center portion of the impeller, an outlet port disposed on the casing for discharging the liquid that has been drawn in from the inlet port, and a flow channel formed spanning from the center portion of the impeller to the peripheral portion of the impeller for guiding the flow of liquid drawn in from the inlet port to the outlet port and of which the right-angle cross-sectional area becomes steadily narrower progressing from the center portion of the impeller toward the peripheral portion of the impeller; being further equipped with a ring shaped partitioning means surrounding the center portion of the impeller and formed on the surface of the interior wall of the casing so as to be in a state of non-contact with said impeller, and a gas introducing means for sending hydrogen and oxygen into the pressurized liquid flowing through the flow channel between the partitioning means and the center portion of the impeller, in which, the liquid discharged from the outlet port is a liquid for generating negative ions in which hydrogen and oxygen have been dissolved or minute gas bubbles of hydrogen and oxygen dispersed.

The negative ion generating liquid manufacturing apparatus according to a sixth aspect of the present invention is a negative ion liquid manufacturing apparatus as described in the fifth aspect of the present invention, in which a plurality of the partitioning means is provided.

The negative ion generating liquid manufacturing apparatus according to a seventh aspect of the present invention is a negative ion liquid manufacturing apparatus as described in any of the first through sixth aspects of the present invention, which is further provided with a depressurizing device for depressurizing and sending downstream the liquid that is to be discharged from the outlet port.

The negative ion generating liquid manufacturing apparatus according to an eighth aspect of the present invention is equipped with a single-stage regenerative pump which is provided with a casing having an inlet port for drawing in a liquid and an outlet port for discharging the liquid drawn in from the inlet port, an impeller provided with a discoid plate having formed on the peripheral portion thereof a plurality of blades and which is disposed within the casing, and a flow channel formed in the casing along the periphery of the impeller for guiding the liquid drawn in from the inlet port to the outlet port and of which the right-angle cross-sectional area in respect of the flow direction of the liquid flowing through the flow channel is of a substantially uniform dimension from the inlet port to the outlet port; being further equipped with a gas introducing means for sending hydrogen and oxygen into the pressurized liquid flowing through the flow channel, the pressure of the liquid flowing through the flow channel steadily increasing as the liquid flows from the inlet port toward the outlet port, at a point along said flow channel, in which, the liquid discharged from the outlet port is a liquid for generating negative ions in which hydrogen and oxygen have been dissolved or minute gas bubbles of hydrogen and oxygen dispersed.

The negative ion generating liquid manufacturing apparatus according to a ninth aspect of the present invention is a negative ion liquid manufacturing apparatus as described in any of the preceding eight aspects of the present invention, in which the gas sent into the pressurized liquid flowing through the flow channel is a gas mixture of hydrogen and oxygen at a molar ratio of 2:1.

According to the first, third, and fourth aspects of the present invention, when the impeller of the single stage pump is operating (rotating), liquid is drawn in from the inlet port, and the liquid drawn in from the inlet port is sent into the flow channel and discharged from the outlet port. Further, though the liquid drawn in at the inlet port is under low pressure, the pressure of the liquid increases as the liquid flows through the flow channel, so that the liquid discharged from the outlet port is under high pressure. The reason that the pressure of the liquid flowing though the flow channel increases to a high pressure as the liquid flows from the inlet port toward the outlet port is because the right angle cross-sectional area of the flow channel becomes steadily narrower with respect to the flow direction of the liquid flowing through the flow channel progressing from the inlet port toward the outlet port. Further, the gas introducing means is capable of sending hydrogen and oxygen into the pressurized fluid flowing though the flow channel, the pressure of the liquid flowing through the flow channel steadily increasing as the liquid flows from the inlet port to the outlet port, from a point along the flow channel. In this manner, because the impeller can stir under a high pressure from the point in the flow channel at which the gas has been injected into the liquid flowing though the flow channel until the liquid is discharged from the outlet port, the liquid into which gas has been mixed, hydrogen and oxygen can thereby be dissolved and dispersed in the liquid.

Further, because the negative ion liquid manufacturing apparatus according to the second aspect of the present invention is provided with at bottleneck portion (a narrow portion of which the right-angle cross-sectional area is narrower in respect of the flow direction of the liquid flowing through the flow channel than the right-angle cross-sectional area of the flow channel), the pressure within the segment of the flow channel between the inlet port and the bottleneck portion can be caused to increase. The gas introducing means is capable of sending hydrogen and oxygen into the pressurized liquid flowing through the flow channel, of which the pressure has been caused to rise because of the bottleneck portion. Therefore, because the impeller can stir under high pressure within the segment of the flow channel between the bottleneck portion and the outlet port the liquid containing mixed therein the gas mixture of hydrogen and oxygen, the hydrogen and oxygen can be dissolved and dispersed in the aforementioned liquid.

According to the fifth aspect of the present invention, a partitioning means which is disposed so as to be in a state of non-contact with the impeller is provided at a point along the flow channel, whereby it becomes possible to raise the pressure within the flow channel along the segment between the inlet port and the partitioning means. That is to say, because the portion of the flow channel which has been provided with the flow channel partitioning means has a right-angle cross-sectional area that is narrow in respect of the flow direction of the liquid flowing through the flow channel, it becomes possible to raise the pressure of the liquid flowing through the flow channel within the segment of the flow channel between the inlet port and the partitioning means. The gas introducing means is capable of sending hydrogen and oxygen into the pressurized liquid flowing through the flow channel by injecting gas into the flow of pressurized liquid, of which the pressure has been caused to rise because of the partitioning means. Accordingly, because the impeller can stir under high pressure the liquid containing mixed therein the hydrogen and oxygen in the segment of the flow channel between the tail end of the partitioning means and the outlet port, the hydrogen and oxygen can be dissolved and dispersed in the liquid.

According to the sixth aspect of the present invention, by providing an appropriate number of the partitioning means, the liquid pressure within the flow channel can be made to be of a desired level. According to the seventh aspect of the present invention, by providing a depressurizing device, the liquid to be discharged from the outlet port can be reduced to a desired pressure.

According to the eighth aspect of the present invention, when the impeller of the single stage pump is operating (rotating), liquid is drawn in from the inlet port, sent into the flow channel, and discharged from the outlet port. Further, though the liquid drawn in at the inlet port is under low pressure, the pressure of the liquid steadily increases as the liquid flows through the flow channel, so that the liquid discharged from the outlet port is under high pressure. The reason that the pressure of the liquid is caused to increase to a high pressure when it flows through the flow channel is because the impeller is capable of using liquid friction to push the liquid within the flow channel in the direction of the outlet port. Further, the gas introducing means is capable of sending gas into the pressurized fluid flowing though the flow channel, the pressure of which steadily increases progressing from the inlet port to the outlet port, from a point along the flow channel. In this manner, because the impeller can stir under a high pressure the liquid into which gas has been mixed from the point along the flow channel at which the gas is sent into the liquid until the liquid is discharged from the outlet port, the gas can thereby be dissolved and dispersed in the liquid.

Further, though the ratio of the hydrogen and oxygen added to the liquid by the gas introducing means is not limited to being of any particular ratio, as described in the explanation of the ninth aspect of the present invention, by using a gas mixture having a molar ratio of 2:1, which is the same as that occurring in water molecules, the quantity of negative ions contained in the obtained negative ion liquid can be maximized, and the oxidation-reduction potential, can be minimized.

In this manner, the negative ion liquid discharged from the outlet port of a negative ion liquid manufacturing apparatus according to any of the above-described aspects of the present invention can be made to include a large amount of negative ions, and also to have an extremely low ORP. That is to say, though there is no standardized method for measuring the ion density of a liquid, if the water discharged from the outlet port is sprayed into the air according to the “Standard for measuring methods of airborne ion density” specified in the JIS standard JIS B9929, a measurement result showing an extremely high density of negative ions compared to the density of positive ions is obtained (a more detailed explanation will be provided hereinbelow). Further, if the ORP of the liquid is measured, an extremely low ORP value is obtained. Here, the “oxidation-reduction potential” refers to the electrical potential created when a certain type of electron exchange occurs, and is a quantitative measurement that can be used to evaluate the propensity of a material to release electrons or receive electrons. In general, the ORP value for pure water is approximately (+) 250 mV, the ORP for tap water approximately (+)400 mv to (+)800 mV, and the ORP of the negative ion liquid obtained according to the present invention is an extremely low value in the range of (−)200 mV to (−)500 mV (a more detailed explanation is provided hereinbelow).

As described above, because the negative ion liquid obtained by the negative ion liquid manufacturing apparatus the according present invention generates a large amount of negative ions and has an extremely low ORP, though the mechanism through which the above-described properties may be rendered effective may not be clear at the time of this application, it is clear that the aforementioned properties are advantageous and extremely useful in a number of ways, including functioning to beneficially effect the health of human beings and animals, to preserve the freshness of foodstuffs over a long period, to purify the air, and so on.

According to the present invention, a low-cost, compact apparatus capable of manufacturing a large amount of negative ion liquid in a short time, having a configuration in which a gas mixture of hydrogen and oxygen is sent into a highly pressurized liquid flowing through the flow channel of a single-stage pump at a point along the flow channel, and the hydrogen and oxygen are mixed with the liquid under a high pressure, whereby the hydrogen and oxygen contained in the gas that has been sent into the highly pressurized liquid flowing through the flow channel can be efficiently dissolved and dispersed in the highly pressurized liquid to obtain a liquid in which a large amount of hydrogen and oxygen has been efficiently dissolved and dispersed, that is to say, a liquid that generates a large amount of negative ions, has an extremely low ORP, and which can advantageously be used in applications for imparting effects on the health of human beings, preserving the freshness of foodstuffs, purifying the air and so on, can be provided as a negative ion liquid manufacturing apparatus.

### BRIEF DESCRIPTION OF THE DRAWINGS

FIG. 1 is a front cross-sectional view of a first embodiment of the negative ion liquid manufacturing apparatus according to the present invention.

FIG. 2a is a cross-sectional view of a single-stage cascade pump along the line A-A according to the first embodiment of the negative ion liquid manufacturing apparatus shown in FIG. 1, and FIG. 2b is a development view of the same single-stage cascade pump as that shown in FIG. 2a.

FIG. 3 is an enlarged cross-sectional view of the injector common to the first through third embodiments of the negative ion liquid manufacturing apparatus according to the present invention.

FIG. 4 is a front cross-sectional view of a second embodiment of the negative ion liquid manufacturing apparatus according to the present invention.

FIG. 5 is a frontal view of the impeller and partitioning means according to the second embodiment of the present invention.

FIG. 6 is a front cross-sectional view of a third embodiment of the negative ion liquid manufacturing apparatus according to the present invention.

FIG. 7 is a frontal view of the impeller and partitioning means according to the third embodiment of the present invention.

FIG. 8 shown an alternative example of a single-stage cascade pump according to the first embodiment of the negative ion liquid manufacturing apparatus of the present invention; FIG. 8a is a development view of the flow channel of the alternate single-stage cascade pump, and FIG. 8b is a partial cross-sectional view of the same alternate single-stage cascade pump as that shown in FIG. 8a.

FIG. 9 is a frontal view of an alternative example of an impeller according to the second embodiment of the negative ion liquid manufacturing apparatus of the present invention.

FIG. 10 is a frontal view of a second alternative example of an impeller according to the second embodiment of the negative ion liquid manufacturing apparatus of the present invention.

FIG. 11 is a frontal view of a third alternative example of an impeller according to the second embodiment of the negative ion liquid manufacturing apparatus of the present invention.

FIG. 12 is a front cross-sectional view of a negative ion liquid manufacturing apparatus according to a reference technology.

FIG. 13 shows a development view of the flow channel of yet another alternative example of a single-stage cascade pump according to the first embodiment of the negative ion liquid manufacturing apparatus of the present invention.

FIG. 14 shows an overview of the entirety of a negative ion liquid manufacturing apparatus according to all of the first through third embodiments of the present invention, as well as the reference technology.

FIG. 15 is a graph showing the test results of an ion density measurement performed on a negative ion liquid manufactured by an embodiment of a negative ion liquid manufacturing apparatus according to the present invention.

FIG. 16 shows photographs of the results of an ORP value measurement test performed on agricultural produce.

FIG. 17 shows photographs of the results of a Change in Degree of Freshness Test 1 performed on agricultural produce.

FIG. 18 is an enlarged photograph of an test group specimen and a contrast group specimen of the spinach that was used in the same agricultural produce Change in Degree of Freshness Test 1 of which the results are shown in FIG. 17.

FIG. 19 shows photographs of the results of a Change in Degree of Freshness Test 2 performed on agricultural produce according to the same actual embodiment of the negative ion liquid manufacturing apparatus of the present invention.

### DETAILED DESCRIPTION OF THE EMBODIMENTS

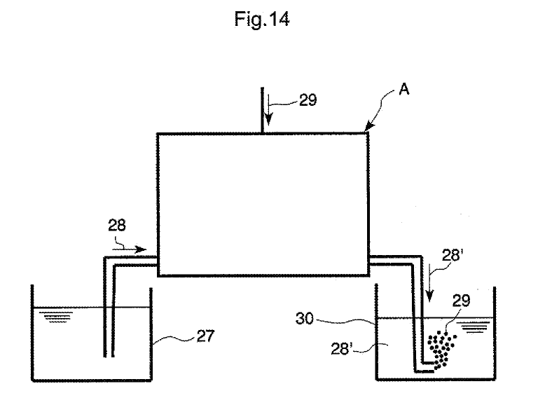

Hereinafter, with reference to the drawings, preferred embodiments of the present invention will be explained in detail. First, the common configuration shared by each of the embodiments described hereinbelow, as shown in FIG. 14, comprises a negative ion liquid manufacturing apparatus A according to the present invention which draws in a liquid stored in an inlet port-side tank 27 (pure water 28 is adopted for explanatory purposes hereinbelow; however, the liquid is not restricted to being pure water, a liquid other than pure water may also be used), and sending into the pure water 28 drawn in from the inlet port-side tank 27 hydrogen and oxygen (for explanatory purposes hereinbelow, a gas mixture of hydrogen and oxygen gases at a 2:1 molar ratio is used, and is referred to hereinafter as “gas mixture 29”) from within the negative ion liquid manufacturing apparatus, whereby pure water 28′ containing the gas mixture 29 dissolved therein and gas bubbles 29′ of the gas mixture 29 dispersed therein is discharged and collected in an outlet port-side tank 30.

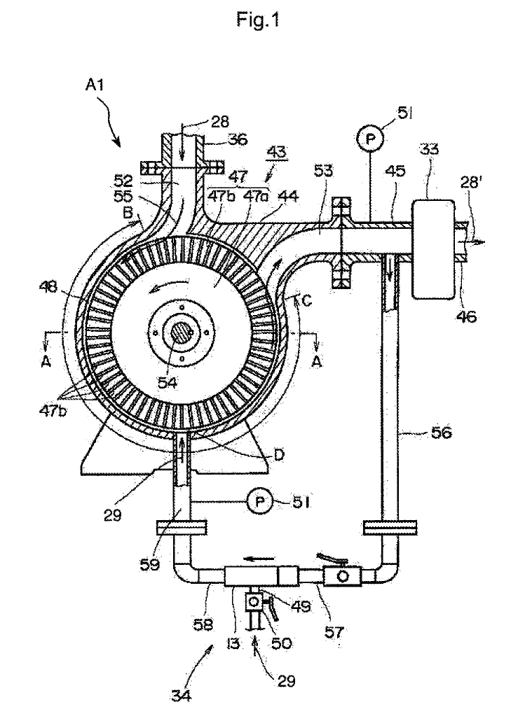

The negative ion liquid manufacturing apparatus A1 according to the current embodiment of the present invention shown in FIG. 1 is an example corresponding to the negative ion liquid manufacturing apparatus of the third aspect of the present invention. That is to say, the negative ion liquid manufacturing apparatus according to the current embodiment is a negative ion liquid manufacturing apparatus for drawing in the pure water 28 (see FIG. 14) stored in the inlet port-side tank 27, dissolving and dispersing in the pure water 28 under high pressure the gas mixture 29, reducing the pressure of the pure water 28′ containing dissolved and dispersed therein the gas mixture 29 and gas bubbles 29′ of the gas mixture 29, and discharging said pure water 28′ into the outlet port-side tank 30.

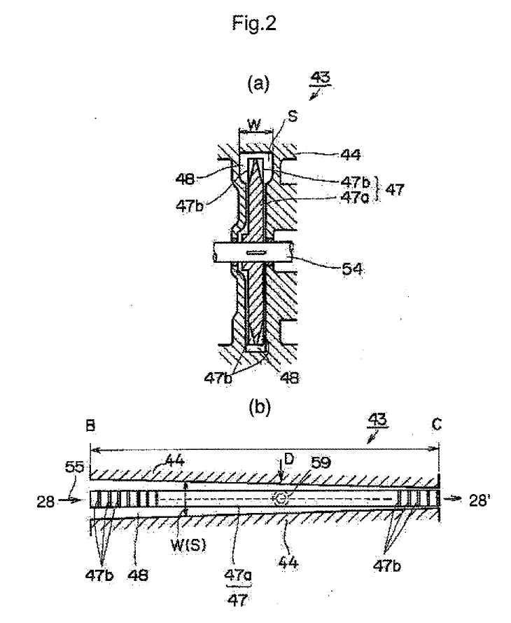

Numeral 43 in FIG. 1 indicates a single-stage regenerative pump (a single-stage cascade pump 43), which forms the main part of the negative ion manufacturing liquid according to the current embodiment, and numeral 34 indicates a gas introducing means 34. The single-stage cascade pump 43 is provided with a casing 44, an impeller 47, and a flow channel 48, and can propel water by means of fluid friction. The casing 44 has an inlet port 52 for drawing in water and an outlet port 53 for discharging water. The impeller 47, as shown in FIG. 1 and FIG. 2a, is provided with a casing 44, and a plurality of impeller blades 47b formed on the peripheral portion of a discoid plate 47a. An shaft 54 is provided coupled to the center of the impeller 47, and the axel 54 is rotatably supported in an axel receiving portion.

The flow channel 48, as shown in FIG. 1, is formed within the casing 44 along the periphery of the impeller 47, and guides the pure water 28 from the inlet port 52 to the outlet port 53. FIG. 2a show a cross-sectional view seen along the line A-A of FIG. 1, and FIG. 2b shows an development view of the flow channel 48 in the range from B to C shown in FIG. 1 looking from the periphery of the impeller 47 toward the center thereof. As can be seen from FIG. 2, the flow channel 48 is formed such that a breadth W of the inner wall of the casing 44 becomes progressively narrower advancing from the inlet port 52 toward the outlet port 53, whereby the right-angle cross-sectional area S of the flow channel in respect of the flow direction 55 of the pure water 28 flowing through the flow channel 48 becomes steadily narrower progressing from the inlet port 52 to the outlet port 53.

Note that the single-stage cascade pump 43, though not shown in the drawings, is coupled to a motor through the shaft 54, and driven by the rotation of the axis 54 by the motor. Further, one end of an inlet pipe 36 is connected to the inlet port 52 shown in FIG. 1, and the other end of the inlet pipe 36 is immersed in the pure water 28 held within the inlet port-side tank 27, as shown in FIG. 14. Continuing, one end of a T-shaped connecting pipe 45 is connected to the outlet port 53, and an discharge pipe 46 is connected to another end of the T-shaped connecting pipe 45 via a depressurizing device (a depressurizing valve) 33. The depressurizing device 33 reduces the pressure of the high-pressure pure water 28′ containing therein dissolved gas mixture 29 and the like and which has been taken in from the intake port thereof to a pressure substantially equal to the atmospheric pressure, and expels the thus depressurized pure water 28′ through the outlet port and discharge pipe 46. The other end of the discharge pipe 46 is inserted into the outlet port-side tank 30 shown in FIG. 14, and is immersed in the discharged pure water 28′. Further, the remaining end of the T-shaped connecting pipe is put in fluid communication with an injector 13 described hereinbelow via a communicating pipe 56.

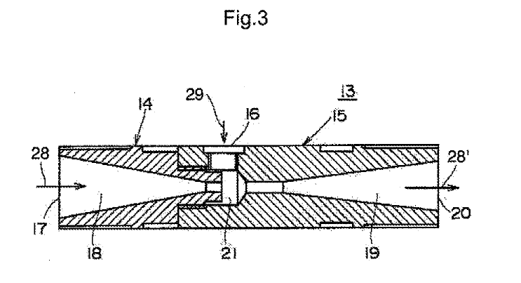

A gas introducing means 34 is a means for sending the gas mixture 29 into the pressurized water flowing through the flow channel 48, the pressure of the water flowing therethrough steadily increases progressing from the inlet port to the outlet port, at a point along the flow channel 48, and is provided with an injector 13, as shown in FIG. 1. The injector 13 is an injector such as that shown in FIG. 3, and an inlet port 17 of a nozzle 14 with which the injector 13 is provided is connected to one end of the communicating pipe 57; the other end of a communicating pipe 57 is connected to an end of the T-shaped connecting pipe via the communicating pipe 56. Further, an output port 20 of a blowout portion 15 of the injector 13 is connected to an end of a communicating pipe 58, and the other end of the communicating pipe 58 is in fluid communication with the flow channel 48 via a communicating pipe 59. The communicating pipe 59, as shown in FIG. 1, is connected to the casing 44 at a midway position D located approximately midway along the portion B-C of the flow channel 48 so as to be in fluid communication with the flow channel 48. Still further, a communicating pipe 49 is connected to a gas intake port 16 of the injector 13, and the communicating pipe 49 is provided with a valve 50. The other opening portion of the valve 50 is open to the atmosphere. The two occurrences of the numeral 51 appearing in FIG. 1 represent pressure meters, which are pressure meters for measuring the pressure inside the T-shaped connecting pipe 45 and the communicating pipe 59.

Next, the procedure for manufacturing the pure water 28′ containing dissolved therein gas mixture 29 and dispersed therein gas bubbles 29′ of the gas mixture 29 with the negative ion liquid manufacturing apparatus A1 according to the current embodiment of the present invention will be explained. First, the single-stage cascade pump 43 is rotationally drive and put in the operating state. When the single-stage cascade pump 43 is operating, pure water 28 is drawn in from the inlet port 52 and discharged from the outlet port 53. A portion of the pure water discharged from the outlet port 53 is diverted into the depressurizing device 33 via the T-shaped connecting pipe 45, depressurized by the depressurizing device 33 to approximately atmospheric pressure, and discharged from the discharge pipe 46. On the other hand, a portion of the pure water discharged from the outlet port 53 is branched off by the T-shaped connecting pipe 45 and diverted through the injector 13; the pure water 28 passing through the injector 13 is sent into the flow channel 48 at the midway position D thereof, merged with the pure water 28 drawn in from the inlet port 52, flows again to the outlet port 53, and is discharged therefrom. In the state in which the pure water 28 is flowing through the injector 13 as described above, the valve 50 of the injector 13 opens. When the valve 50 is open, the pure water 28 flowing through the injector 13 can be intermingled and mixed with the gas mixture 29 taken in from the intake port 16 of the injector 13, and the pure water 28 into which the gas mixture 29 has been mixed can be blown out from the output port 20 of the blowout portion 15.

Further, though the pressure of the pure water 28 is under low pressure when drawn in at the inlet port 52, the pressure of the pure water 28 drawn in by the inlet port 52 steadily increases as said pure water 28 flows through the flow channel 48, whereby high-pressure pure water 28′ is discharged from the outlet port 53. The reason that the pressure of the pure water 28 is caused to rise to a high pressure when said pure water 28 flows through the flow channel 48 is that the width S of the flow channel 48 (the area of the right-angle cross-section of the flow channel with respect to the flow direction of the pure water 28 flowing therethrough) becomes steadily narrower progressing from the inlet port 52 side of the flow channel 48 to the outlet port 53 side of the flow channel 48. Further, the gas introducing means 34 can send pure water 28′ containing dissolved and dispersed therein the gas mixture 29 into the flow channel 48 through which the pure water 28 flowing therethrough steadily increases in pressure from a point D along said flow channel 48 through which the pressurized pure water 28 passes. In this manner, because it becomes possible for the impeller 47 to stir under high pressure in the segment of the flow channel 48 from the point D along the flow channel 48 up till the outlet port 53 the pure water 28 into which the gas mixture 29 has been mixed, a large amount of the gas mixture 29 can be efficiently dissolved and dispersed into the pure water 28.

Further, when the pure water 28′ into which the gas mixture 29 has been dissolved and dispersed under high pressure as described above is depressurized by the depressurizing device 33, and collected in the outlet port-side tank 30 as shown in FIG. 14, a plurality of microscopic gas bubbles 29′ are generated, and the pure water 28′ in which the hydrogen and oxygen gas mixture 29 has been efficiently dissolved therein, and minute gas bubbles 29′ of the gas mixture 29 dispersed therein, can be obtained. Still further, according to the negative ion liquid manufacturing apparatus A1 of the above-described configuration according to the present invention, because the cascade pump 43 is a single-stage type cascade pump, the cost of the apparatus can be kept low, and the apparatus can be made compact in size and lightweight.

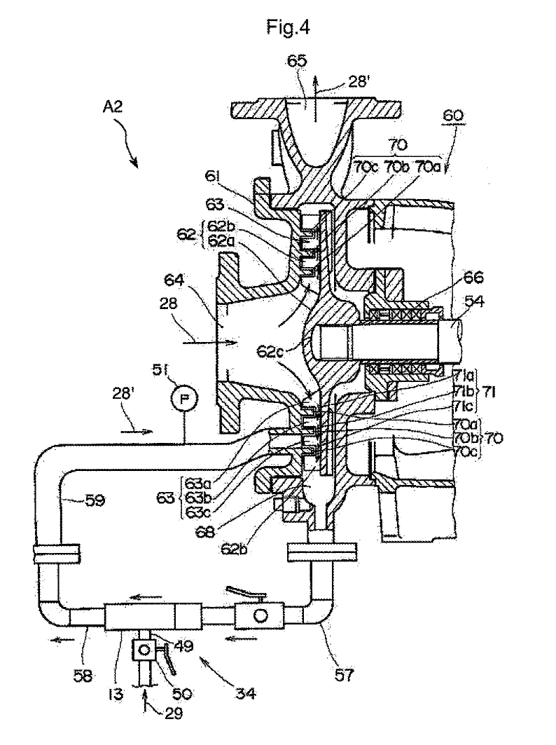

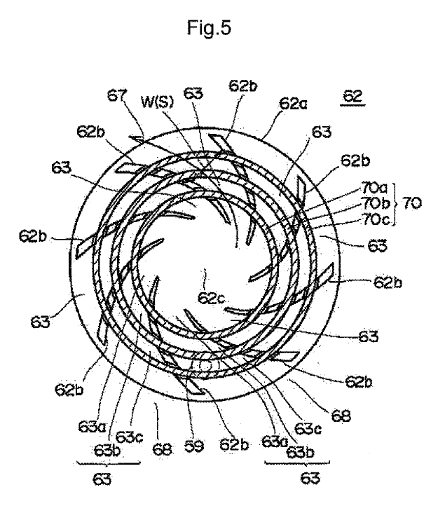

The negative ion liquid manufacturing apparatus A2 according to a second embodiment of the present invention is an example of a negative ion liquid manufacturing apparatus corresponding to the fifth aspect of the present invention, and will be explained with reference to FIGS. 4 and 5. The point of difference between the negative ion liquid manufacturing apparatus A1 according to the first embodiment and the negative ion liquid manufacturing apparatus A2 according to the second embodiment of the present invention is that whereas the first embodiment adopts the single-stage cascade pump 43, the second embodiment adopts a single-stage centrifugal pump 60 provided with an open-type impeller 62. The single-stage centrifugal pump 60 is provided with a casing 61, an impeller 62, a flow channel 63, and a partitioning means 70. As shown in FIG. 4, the casing 61 has an inlet port 64 for drawing in a liquid (pure water 28) and guiding the drawn-in pure water 28 to the center portion 62c of the impeller 62, and an outlet port 65 for discharging the pure water 28 that has been drawn in from the inlet port 64. The open-type impeller 62, as shown in FIG. 4, is provided as a single unit within the casing 61, and is formed as an open-type impeller comprising a discoid plate 62a having formed on the side face of the inlet port-side 64 thereof eight impeller blades 62b. Each of the impeller blades 62b are separated by an equidistant interval and together form a whirlpool pattern spanning from the center portion of the discoid plate 62a to the peripheral portion of said discoid plate 62a. The center portion of the impeller 62 has coupled thereto an shaft 54, and the shaft 54 is rotatably supported by an bearing 66.

The flow channel 63 is a flow channel that comprises eight flow channels formed between each of adjacent impeller blades 62b of the eight impeller blades 62b provided on the impeller 62, through which the pure water 28 that is drawn in from the inlet port 64 and guided to the center portion 62c of the impeller 62 is directed to the outlet port 65 by centrifugal force. As shown in FIG. 5, the eight flow channels 63 are formed so that the interval W between the inner faces of each two impeller blades 62b forming each of the flow channels 63 becomes progressively wider from the inlet port 64 toward the outlet port 65, whereby the right-angle cross-sectional area S in respect of the flow direction 67 of the pure water 28 flowing the flow channels 63 becomes progressively wider from the center-portion end of said flow channels 63 (i.e., the inlet port 64 end thereof) to the peripheral-portion end of said flow channels 63 (i.e., the outlet port 65 end thereof).

The partitioning means 70 (i.e., 70a, 70b, and 70c) are formed on the inner surface of the wall of the casing 61 that is counterposed to the impeller blades 62b and disposed so as not to be in a state of non-contact with the impeller 62, as three concentric ring-shaped protrusions each of different diameters which are centered on the center portion 62c of the impeller 62. The three partitioning means 70a, 70b and 70c are provided mutually separated by an equidistant interval, and are disposed within the notches provided on each impeller blade 62ba with a gap separating each respective partitioning means 70 from the inner edge of said notches. In this manner, each flow channel 63 is separated into three chambers, first chamber 63a, second chamber 63b and third chamber 63c by the three partitioning means 70a, 70b and 70c. Note that the third chamber 63c has formed on the outside thereof a whirlpool chamber 68. Further, the interval between the distal end portion of each partitioning means 70a, 70b and 70c and the discoid plate 62a of the impeller 62 is narrow, and each of said intervals forms a bottleneck portion 71 (i.e., 71a, 71ab and 71c). That is to say, the bottleneck portions 71 are portions at which the right-angle cross-sectional area S of the of the flow channel 63 in respect of the flow direction 67 of the pure water 28 flowing through said flow channel 63 becomes exponentially narrower. The bottleneck portions 71 correspond to the bottleneck portion according to the second aspect of the present invention.

The partitioning means 70a, 70b and 70c enable the velocity energy of the pure water 28 passing through the bottleneck portions 71a, 71b and 71c to be converted to pressure energy, whereby the pressure within the flow channel 63 can be caused to steadily increase in the order of progression from the first chamber 63a through the second and third chambers 63b and 63c and to the whirlpool chamber 68, with the pressure within the whirlpool chamber 68 being the highest. By providing a number of the partitioning means 70 in a quantity higher than the three partitioning means 71a-71c described above, the pressure of the pure water 28 flowing within the flow channel 63 can be caused to be raised to a desired level, however, the higher the number of the partitioning means 70 provided, the smaller the volume of the pure water 28 discharged through the outlet port 65; to control the reduction in the volume of discharged pure water 28, the interval between the impeller blades 62 must be widened and the diameter of the impeller made larger. Accordingly, the appropriate number of the partitioning means 70 to be provided must be determined based on taking into account the water pressure within the chambers to be formed within the flow channel 63 and the water discharging volume of the pump 60.

Note that the single-stage centrifugal pump 60, though not shown in the drawings, is provided with an shaft 54 coupled to a motor, and the single-stage centrifugal pump 60 is driven by rotation of the motor. Further, though not shown in the drawings, in the same manner as that of the first embodiment of the present invention, one end of an inlet pipe 36 is connected to an inlet port 64, and the other end of the inlet pipe 36 is immersed in the pure water 28 contained in the inlet port-side tank 27 shown in FIG. 14. Still further, though not shown in the drawings, a connecting pipe is connected to the outlet port 65, and a depressurizing device 33 the same as that of the first embodiment is connected at the input end thereof to said connecting pipe, and at the output end thereof to the discharge pipe 46. The discharge pipe 46 is immersed in the pure water 28′ discharged into the outlet port-side tank 30 show in FIG. 14. Further, as show in FIG. 4, the injector 13 is connected to the whirlpool chamber 68, which is in fluid communication with the outlet port 65, via a communicating pipe 57 or the like.

The gas introducing means 34 is a means for sending the gas mixture 29 into the pressurized pure water 28, the pressure of the pure water 28 steadily increasing as it flows through the flow channel 63, at the third chamber 63c of the three chambers 63a-63c formed in the flow channel 63. The gas introducing means 34 is the same as the gas introducing means according to the first embodiment of the present invention, and a detailed description thereof is therefore omitted. The output port 20 of the blowout portion 15 of the injector 13 of the gas introducing means 34 is in fluid communication with the third chamber 63c via communicating pipes 58 and 59. Note that the numeral 51 show in FIG. 51 represents a pressure meter which is a pressure meter for measuring the pressure within the communicating pipe 59. Though not shown in the drawings, a pressure meter is also provided for measuring the pressure at the outlet port 65.

Next, the procedure for manufacturing the pure water 28′ containing dissolved therein the gas mixture 29 and dispersed therein gas bubbles 29′ of the hydrogen and oxygen gas mixture 29 with the negative ion liquid manufacturing apparatus A2 of the above-described configuration will be explained. First, the single-stage centrifugal pump 60 is rotationally driven and put in the operating state. When the single-stage centrifugal pump 60 is operating, the centrifugal pump 60 causes the pure water 28 to be drawn in from the inlet port 64, to flow through the flow channel 63 and the whirlpool chamber 68, and to be discharged from the outlet port 65. The pure water 28′ discharged from the outlet port 65 is directed into a depressurizing device 33 the same as that of the first embodiment via a communicating pipe (not shown), depressurized to approximately atmospheric pressure by the depressurizing device 33, and discharged from the discharging pipe 46. On the other hand, a portion of the pressurized pure water 28′ sent into the whirlpool chamber 68 is diverted to the injector 13 via the communicating pipe 57; the pure water 28′ that has passed through the injector 13 is directed into the third chamber 63c of the flow chamber 63, merged into the flow of the pure water 28 drawn in from the inlet port 64, and again flows to the outlet port 65 and is discharged therefrom. Note that as described above for the first embodiment, when the valve 50 is open, the pure water 28 flowing through the injector 13 can be intermingled and mixed with the gas mixture 29 drawn in by the gas intake port 16 of the injector 13, and the pure water 28′ into which the gas mixture 29 has been mixed can be blown out from the output port 20 of the blowout portion 15.

Further, though the pure water 28 is of low pressure when drawn in at the inlet port 64, the pressure of the pure water 28 drawn in from the inlet port 64 steadily increases as it flows through the flow channel 63 in the order of progression from the first chamber 63a through to the third chamber 63c and the whirlpool chamber 68, and is discharged from the outlet port 65 as high-pressure pure water 28. The reason that the pressure of the pure water 28 is increased to a high pressure as it flows through the flow channel 63 is because the bottleneck portions 71a through 71c have been formed on the partitioning means 70a through 70c along the flow channel 63. Further, the gas introducing means 34 is capable of sending pressurized pure water 28 containing air into the pressurized pure water 28 contained in the third chamber 63c. In this manner, because it is possible for the impeller 62 to stir under high pressure, within the third chamber 63c and within the whirlpool chamber 68 formed on the outside of said third chamber 63c, by means of the impeller blade 62b positioned in said third chamber 63c and whirlpool chamber 68 the pure water 28 into which the gas mixture 29 has been introduced, a large amount of the gas mixture 29 can be efficiently dissolved and dispersed into the pure water 28.

Further, when the pure water 28′ into which the gas mixture 29 has been dissolved and dispersed under high pressure as described above is depressurized by the depressurizing device 33, and collected in the outlet port-side tank 30, in the same manner as described above for the first embodiment, a plurality of microscopic gas bubbles 29′ are generated, and the pure water 28′ in which the hydrogen and oxygen gas mixture 29 has been efficiently dissolved therein, and minute gas bubbles 29′ of the gas mixture 29 dispersed therein, can be obtained. Still further, according to the negative ion liquid manufacturing apparatus A2 of the above-described configuration, because the centrifugal pump 60 is a single-stage pump, the cost of the apparatus can be kept low, and the apparatus can be made compact in size and lightweight.

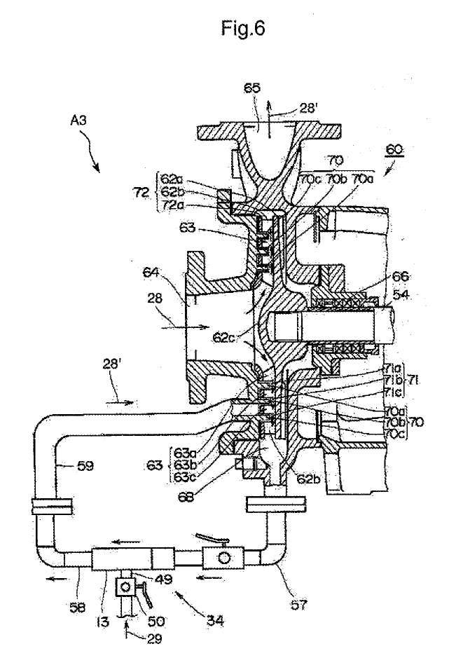

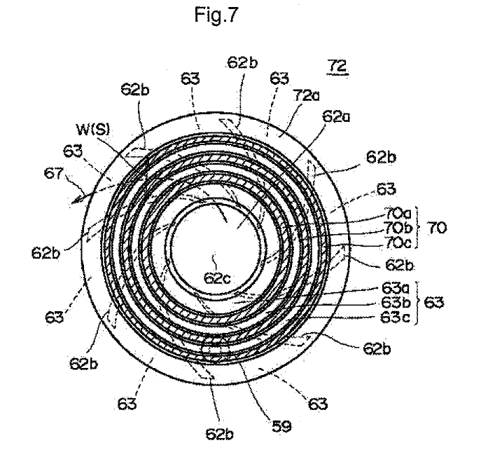

The third embodiment of the negative ion liquid manufacturing apparatus A3 according to the present invention will now be explained with reference to FIGS. 6 and 7. The point of difference between the negative ion liquid manufacturing apparatus A2 according to the second embodiment and the negative ion liquid manufacturing apparatus A3 according to the third embodiment of the present invention is that whereas the single-stage centrifugal pump 60 applied in the second embodiment is provided with an open impeller 62, a single-stage centrifugal pump 60 provided with a sealed-type impeller 72 is applied in the third embodiment. Aside from the above-described point of difference, equivalent portions shared in common with the second embodiment are labeled with the same numerals in the corresponding drawings, and a detailed explanation thereof is omitted. Though not shown in the drawings, the sealed impeller 72, in contrast to the open impeller 62 of the second embodiment, is provided with a ring shaped front cover panel 72a, which is counterposed to the discoid plate 62a at a position separated from said discoid plate 62a by an open interval. There are eight impeller blades 62b disposed between the front cover panel 72a and the discoid plate 62a.

Utilizing the sealed impeller 72 enables the efficiency of the pump to be improved. Aside from the above-described points, the negative ion liquid manufacturing apparatus A3 according to the third embodiment is capable of efficiently dissolving and dispersing a large amount of the gas mixture 29 within the pure water 28, in the same manner as the vapor and liquid mixing apparatus A2 according to the second embodiment of the present invention.

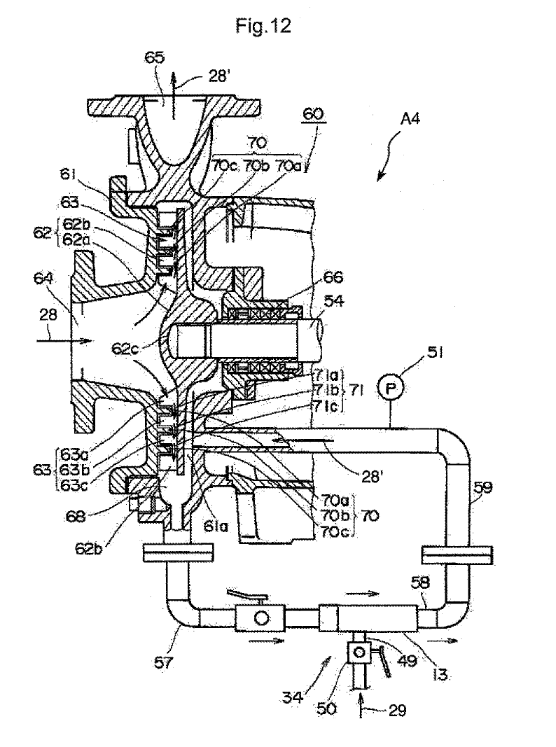

Next, a reference technology will be explained with reference to FIG. 12. The points of difference between the negative ion liquid manufacturing apparatus A2 according to the second embodiment of the present invention and the reference technology negative ion liquid manufacturing apparatus A4 shown in FIG. 12 is that in contrast to the configuration of the negative ion liquid manufacturing apparatus A2 shown in FIG. 4, wherein the output port 20 of the blowout portion 15 of the injector 13 of the gas introducing means 34 is in fluid communication with the third chamber 63c via the communicating pipes 58 and 59, the configuration of the reference technology negative ion liquid manufacturing apparatus A4, as shown in FIG. 12, is such that the output port 20 of the blowout portion 15 of the injector 13 of the gas introducing means 34 is in fluid communication with a gap 61a formed between the side face of the discoid plate 62a opposite the side thereof on which the flow channel 63 is formed and the surface of the interior wall of the casing 61 that faces said side face via the communicating pipes 58 and 59. Aside from the above-described point of difference, equivalent portions shared in common with the second embodiment are labeled with the same numerals in the corresponding drawings, and a detailed explanation thereof is omitted.

The gas introducing means 34 can supply high-pressure pure water 28 mixed therein the gas mixture 29 into the gap 61a formed between the casing 61 and the discoid plate 62a of the impeller 62, and the high-pressure pure water 28 containing mixed therein the gas mixture 29 that is sent into the gap 61a is then sent by the centrifugal force of the impeller 62 into the whirlpool chamber 68 formed on the peripheral portion of the impeller 62. In this manner, because it becomes possible for the impeller 62 to stir the pure water 28 mixed therein the gas mixture 29 under high pressure, the gas mixture 29 can be efficiently dissolved and dispersed in said pure water 28. Note that because the gas introducing means 34 sends the pure water 28 containing mixed therein the gas mixture 29 to the above-described gap 61a and not to the flow channel 63, the impeller blades 62b of the impeller 62 are not caused to spin idly by the air within the high-pressure pure water 28, whereby the pure water 28′ can be discharged from the outlet port 65 under high pressure. According to the above-described reference technology, the partitioning means 70a, 70b and 70c are provided, and the partitioning means 70 are configured such that the gas mixture 29 contained in the whirlpool chamber 68 does not move to the inlet port 64 through the flow channel 63. However, the number of partitioning means 70a through 70c to be provided can be adjusted in correspondence with the flow rate of the pure water 28 within the flow channel 63 and the volume of the gas mixture 29, and in some cases can be omitted. Aside from the above-described points, the reference technology negative ion liquid manufacturing apparatus A4 is capable of efficiently dissolving and dispersing a large amount of the gas mixture 29 within the pure water 28, in the same manner as the negative ion liquid manufacturing apparatus A2 according to the second embodiment of the present invention.

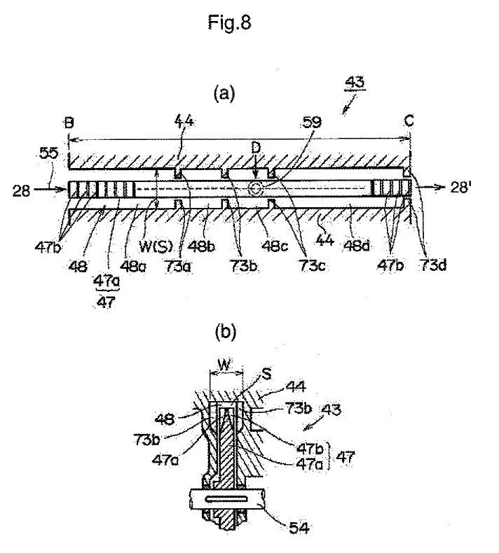

However, the width W of the flow channel 48 of the single-stage cascade pump 43 of the first embodiment, as shown in the development view depicted in FIG. 2b, is formed such that it becomes steadily narrower progressing from the inlet port 52 to the outlet port 53, and though the flow channel is configured so that the water pressure at the position D thereof becomes a high pressure, instead of the configuration of the flow channel 48 shown in FIG. 2b, as shown in the development view depicted in FIG. 8a and the partial cross-sectional view of FIG. 8b, the width W of the flow channel 48 can be formed so as to be uniform across the entire length thereof, and four partitioning means 73a, 73b, 73c and 73d mutually separated by a predetermined interval can be formed by a group of four protrusion portions on the inner surfaces of both walls of the flow channel 48. The partitioning means 73a, 73b, 73c and 73d are partitioning means for carrying out the same operational role as the partitioning means 70a through 70c according to the second and third embodiments described above; wherein the water pressure within a first, second, third, and fourth chambers 48a, 48b, 48c, and 48d formed on the inlet port-side of the partitioning means 73a, 73b, 73c and 73d becomes successively higher in the order of progression thereof, the water pressure becoming highest within the fourth chamber 48d. Further, pure water 28 that is of a lower pressure than the high-pressure water discharged from the outlet port 53 but nonetheless of a comparatively high pressure flows into the third chamber 48c; whereby it becomes possible to efficiently dissolved and dispersed into the pure water 28 a large amount of the gas mixture 29 in the same manner as for each of the embodiments described above.

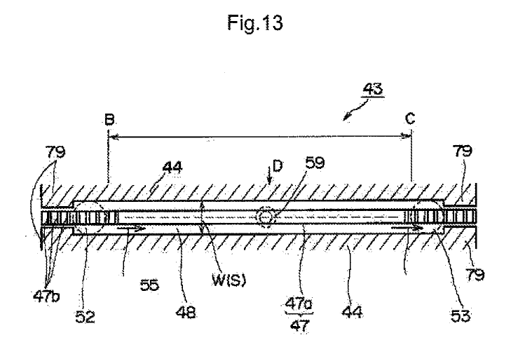

Still further, the flow channel 48 of the single-stage cascade pump 43 of the first embodiment of the present invention can even be of another alternative type. That is to say, as shown in FIG. 13, the right-angle cross-sectional area of the flow channel 48 in respect of the flow direction of the pure flow that is to flow therethrough can be formed at a substantially uniform dimension from the inlet port 52 to the outlet port 53 (i.e., within the segment B-C), and from the outlet port 53 to the inlet port 52 (i.e., segments other that the B-C segment) can be provided with a partitioning means 79 and formed narrower than the B-C segment. According to the above-described single-stage cascade pump 43, when the impeller 47 is operating, the pure water 28 is drawn in from the inlet port 52, and the drawn in pure water 28 is then sent into the flow channel 48 and discharged from the outlet port 53. Further, though the pressure of the pure water 28 within the inlet port 52 is a low pressure, the pressure of the pure water 28 drawn in by the inlet port 52 steadily increases as said pure water 28 flows through the flow channel 48, whereby high-pressure pure water 28′ is discharged from the outlet port 53. The reason that the pure water 28 comes to have a higher pressure when it flow through the flow channel 48 is because the impeller 47 pushes the pure water 28 using fluid friction into the flow channel 28 that is surrounded by the partitioning means 79 positioned on the portion of said flow channel 48 near the outlet port 53. Further, the gas introducing means 34 can send pure water 28 together with the gas mixture 29 into the pressurized pure water 28 flowing through the flow channel 48, the pressure of said pure water 28 flowing through the flow channel steadily increasing as said pure water 28 flows through said flow channel, from the midway point D along the flow channel 48. In this manner, because it becomes possible for the impeller 47 to stir under high pressure in the segment of the flow channel 48 from the midway point D of the flow channel 48 until the outlet port 53 the pure water 28 into which the gas mixture 29 has been introduced, a large amount of the gas mixture 29 can be efficiently dissolved and dispersed into the pure water 28.

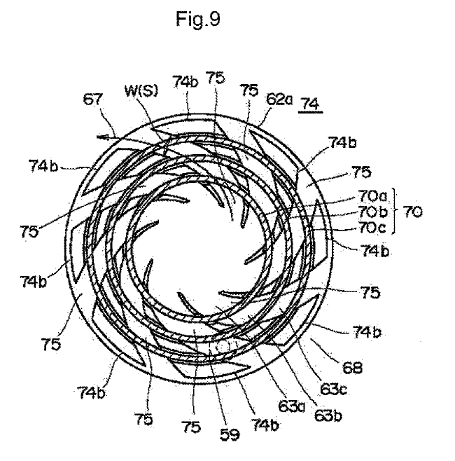

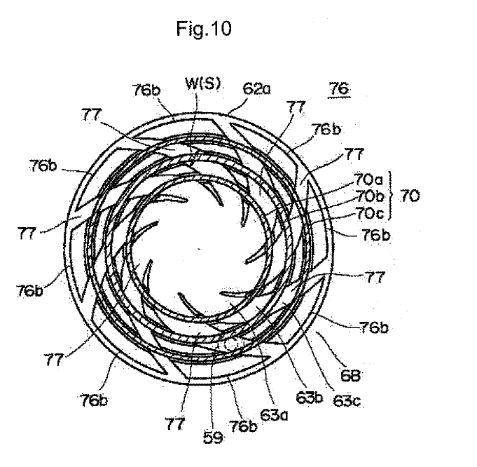

Further, according to the second embodiment of the present invention, as shown in FIG. 5, each of the eight flow channels 63 are formed so that the interval W between the inner surfaces of the two respective the impeller blades 62b that form each flow channel 63 becomes progressively wider from the inlet port 64 toward the outlet port 65, whereby the right-angle cross-sectional area S in respect of the flow direction 67 that the pure water 28 flows through the flow channels 63 becomes progressively wider from the center portion end thereof (i.e., the inlet port 64 end thereof) to the peripheral portion end thereof (i.e., the outlet port 65 end thereof); however, the configuration shown in FIG. 9 or FIG. 10 can also be employed.

As shown in FIG. 9, each of the eight flow channels 75 of the impeller 74 are formed so that the interval W between the inner surfaces of the two respective the impeller blades 74b that form each flow channel 75 is of a substantially uniform dimension at each point therealong from the inlet port 64 toward the outlet port 65, whereby the right-angle cross-sectional area S in respect of the flow direction 67 of the pure water 28 flowing the flow channel is substantially uniform at each point therealong from the center portion end thereof (i.e., the inlet port 64 end thereof) to the peripheral portion end thereof (i.e., the outlet port 65 end thereof). Other than the above-described differences, the impeller 74 is the same as the impeller 62.

As shown in FIG. 10, each of the eight flow channels 77 of the impeller 76 are formed so that the interval W between the inner surfaces of the two respective the impeller blades 76b that form each flow channel 77 becomes steadily narrower progressing from the inlet port 64 end thereof toward the outlet port 65 end thereof, whereby the right-angle cross-sectional area S in respect of the flow direction 67 of the pure water 28 flowing the flow channel becomes steadily narrower progressing from the center portion end thereof (i.e., the inlet port 64 end thereof) to the peripheral portion end thereof (i.e., the outlet port 65 end thereof). Other than the above-described differences, the impeller 76 is the same as the impeller 62. By employing a configuration wherein the cross-sectional area S of the flow channel 77 becomes progressively narrower therealong in respect of the flow direction 67, the pressure of the pure water 28 flowing through the flow channel 77 can be steadily increased as said pure water 28 flows from the center portion of the impeller 76 (i.e., the inlet port 64 end of the flow channel 77) toward the peripheral portion of the impeller 76 (i.e., the outlet port 65 of the flow channel 77).

Note that the impeller 74 shown in FIG. 9 and the impeller 76 shown in FIG. 10 are provided in an open-type construction, however, each of said impellers 74 and 76 may be provided with a ring-shaped front cover panel 72a, in the same manner as shown in FIGS. 6 and 7, so as to be provided in a sealed-type construction.

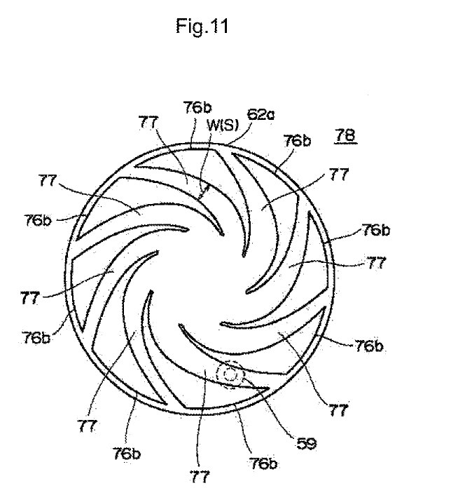

Further, the vapor and liquid mixing apparatus according to the current embodiment of the present invention may be provided in a configuration wherein the partitioning means 70a, 70b, and 70c shown in FIGS. 4 and 5 for the second embodiment are omitted, and the open-type impeller 78 instead show in FIG. 11 is provided instead of the impeller 62. The impeller 78 is formed without the notches for accommodating the partitioning means 70a, 70b, and 70c of the impeller 76 shown in FIG. 10 (the three notches formed on the concentric rings), and is otherwise of the same configuration as the impeller 76. Of course, though not shown in the drawings, instead of the open-type impeller 78 shown in FIG. 11, the negative ion liquid manufacturing apparatus according to the current embodiment may be of a configuration wherein the impeller 78 is provided with the ring-shaped front cover 72a to make it a sealed-type impeller.

Further, though a configuration wherein a quantity of three partitioning means 70a, 70b and 70c of the partitioning means 70 has been adopted in the second and third embodiments, a configuration comprising a quantity of the partitioning means other than three, such as one or four or more of the partitioning means 70 may also be adopted. Further, though a configuration wherein the output port 20 of the blowout portion 15 of the injector 13 of the gas introducing means 34 is put into fluid communication with the third chamber 63c via the communicating pipe 59 has been adopted in the second and third embodiments, a configuration wherein the output port 20 of the blowout portion 15 of the injector 13 is in fluid communication with the first chamber 63a or the second chamber 63b may also be adopted. Further, according to the first through third embodiments, a configuration comprising the depressurizing device 33 has been adopted, however, a configuration wherein the depressurizing device 33 is omitted and the pure water 28′ containing dissolved and dispersed therein the gas mixture 29 is discharged at a high velocity may also be adopted.

Still further, according to the first through third embodiments, a configuration wherein the injector 13 is used to send a gas mixture into the pure water 28 has been adopted, however, a configuration wherein the injector 13 is not provided, and a predetermined amount of the gas mixture 29 is forcibly mixed into the pure water 28 passing through each point corresponding to the position of an injector 13 may also be adopted. Regarding a device for forcibly providing the gas mixture 29, a compressor, for example, may be employed. However, the compressor must be provided with a flow amount regulating valve at the air expulsion port thereof in order to facilitate adjustment of the amount of gas to be supplied therefrom. Of course, a configuration wherein the injector 13 and the communicating pipe are omitted, and the gas mixture 29 is compressed and sent into the flow channel directly at the position D therealong or into the third chamber 63c may also be adopted.

Further, the negative ion liquid manufacturing apparatus A according to the first through third embodiments may be applied in, for example, an air purification apparatus which utilizes the ultrasound waves generated when the gas bubbles of the gas mixture burst. In that case, it is desirable that the liquid in which the gas mixture is dissolved and dispersed is a liquid detergent or the like. Further, the by generating gas bubbles in bath water, the negative ion liquid manufacturing apparatus A may also be used for providing a cleansing body massage. Still further, the negative ion liquid manufacturing apparatus A may also be used as an apparatus for cleaning of lakes and other bodies of fresh water. In addition, the water containing dissolved and dispersed therein the gas mixture 29 manufactured by the negative ion manufacturing apparatus A may be employed in an air purification system for spraying said water into the air, or systems for immersing foodstuffs or fresh flowers into said water in order to preserve the freshness thereof.

Note that the present invention is not limited to being employed only in the above-described embodiments. In addition, the detailed configuration of each of the above-described parts is not limited to the configuration described in conjunction with each of said embodiments, and in so far as the gist of the present invention is not deviated from, any number of variations thereof are possible.

### Analytical Experiments Employing of an Actual Embodiment

Ion Density Measurement Experiment—in order to prove that the water containing dissolved therein hydrogen and oxygen of a gas mixture and dispersed therein microscopic gas bubbles of the gas mixture (hereinafter referred to as “negative ion water”) manufactured by the negative ion liquid manufacturing apparatus according to the present invention contains a large amount of negative ions, we conducted an experiment in which the negative ion water manufactured with the negative ion liquid manufacturing apparatus of the first embodiment of the present invention described above was sprayed into the air and the ion density thereof measured.

The conditions under which the measurement was carried out are as follows:

Measurement device: The inti air-borne ion counter ITC-201A (manufactured by Andes Electric, Co., Ltd.) was employed as the device for measuring the concentration of ions.
Measurement method and conditions: Utilizing an ion measurement device conformant with the above-described JIS standard “Standard for measuring methods of airborne ion density” (JIS B9929), pure water not processed by the negative ion liquid manufacturing apparatus and pure water subjected to processing by the negative ion manufacturing apparatus were sprayed strongly from the same spray bottle by the same person for an interval of three minutes each, and the quantity of negative and positive ions contained in a lcc volume sample of air was measured for each. Note that the above-described ion measuring device is a measurement instrument having fixed to the aperture thereof a hermetically sealing door, and is provided with an air blowing portion, and air filtering portion, anion generator (the aforementioned spray bottle), amounting portion, a constricted flow mixing portion, and a measuring portion. Through checks we determined that the temperature within the interior of the measuring device was in the range of 21-23° C., humidity was maintained in the 34-40% range, and the pH of the pure water before processing and the negative ion water was 7 (neutral).

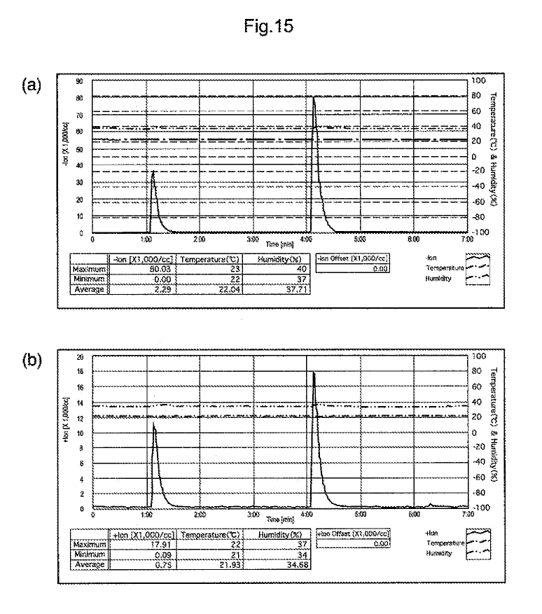

The results obtained by the ion density measuring device are shown on the graph in FIG. 15. The measurement results for negative ions are shown in FIG. 15a, and the measurement results for positive ions in FIG. 15b. As can be seen from the results shown in FIGS. 15a and 15b, immediately after the pure water is sprayed (one minute after the measurement operation begins), immediately after the negative ion water is sprayed (four minute after the measurement operation begins), the density levels for both negative ions and positive ions rises sharply, and it is clear from the scale on left side of the y axis of both of the aforementioned graphs that the measured density of negative ions was remarkably higher in comparison to the measured density of positive ions. That is to say, the density of negative ions shown in FIG. 15a was 35.68 (×1000/cc) one minute and seven seconds after the start of the measurement (immediately after the spraying of the pure water), 80.03 (×1000/cc) four minutes and eight seconds after the start of the measurement (immediately after the spraying of the negative ion water); whereas, the density of positive ions shown in FIG. 15b was 10.96 (×1000/cc) one minute and eight seconds after the start of the measurement (immediately after the spraying of the pure water), 17.91 (×1000/cc) four minutes and eight seconds after the start of the measurement (immediately after the spraying of the negative ion water). Accordingly, a result showing that the density of negative ions was higher than the density of positive ions both at the time of spraying the pure water and at the time of spraying the negative ion water was obtained.

From the above-described results, comparing the highest ion density values, it can clearly be seen that approximately 2.2 times the amount of negative ions and approximately 1.6 times the amount of positive ions are generated by the negative ion water compared to the pure water, and that the negative ion water generated 4.4 times more negative ions than positive ions. This result indicates that the negative ion water manufactured by the negative liquid manufacturing apparatus according to the present invention, by adding to pure water under high a gas mixture of hydrogen and oxygen and thereby dissolving in the pure water hydrogen and oxygen of the gas mixture or dispersing gas bubbles of the gas mixture in the pure water, the hydrogen contained in the gas mixture is caused to be ionized, yielding an amount of electrons from negative ions in the negative ion water equal to approximately 2.2 times (estimated) the amount contained in the pure water prior to processing by the negative ion liquid manufacturing apparatus of the present invention.

Negative Ion Water ORP Value Measurement Experiment—In order to confirm that the negative ion water manufactured by the negative ion liquid manufacturing apparatus according to the present invention has an extremely low ORP value, to well water to which hypochlorous acid was added (i.e., everyday tap water) by the negative ion liquid manufacturing apparatus according to the present invention, and the negative ion water manufactured therefrom subjected to measurement of the ORP value thereof. In carrying out the experiment, an ORP meter available on the open market (ORP Meter RM-20P manufactured by DKK-TOA Corporation, with a sliver-silver chloride electrode (PST-2739C by the same manufacturer)) was employed, with the water temperature at 13° C., and the pH at 7. Note that the ORP value was also measured under the same conditions for the well water to which hypochlorite was added (place of measurement experiment: (Hokutaku Foods, Ltd., Shibetsu City, Hokkaido, Japan).

An 80 m³ water storage tank was used for the ORP value measurement experiment, and the results taken over a period of one month showed that against a result of an average ORP value of (−)270 mV obtained for the negative ion water, the average ORP value obtained for the well water to which hypochlorite had been added was (+)530 mV. The above-described result clearly shows that the negative ion water manufactured by the negative ion liquid manufacturing apparatus according to the present invention is in a state of having an extremely low ORP value.

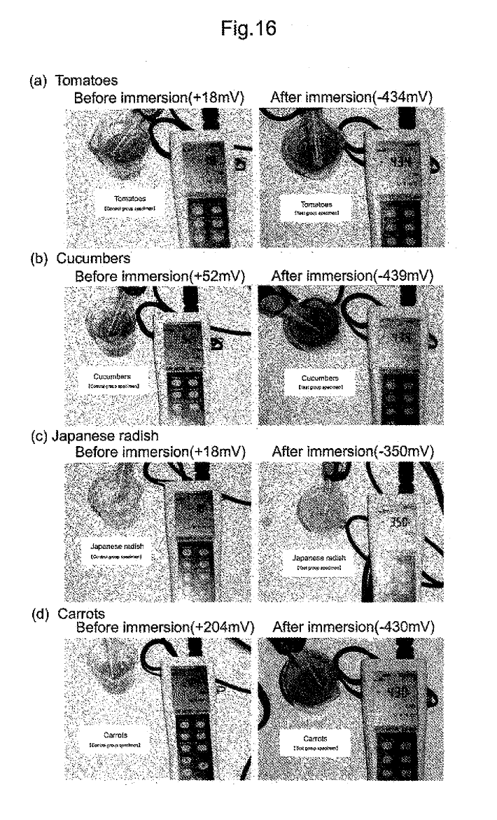

Agricultural Produce ORP Value Measurement Experiment—This experiment was conducted to assess the type of change in ORP value that would result if farm produce was immersed in the negative ion water (with an ORP value of (−)279 mV) manufactured by the negative ion liquid manufacturing apparatus according to the present invention. The agricultural produce used for the experiment was of four types: tomatoes, cucumbers, Japanese radish, and carrots. For the measurement, the same ORP meter as that employed in the above-described negative ion water ORP value measurement experiment was used. The measurement experiment was carried out by comparing the ORP value for the agricultural produce measured before the agricultural produce were immersed in the negative ion water to the ORP value for the agricultural produce measured after the agricultural produce were immersed in the negative ion water for a period of two hours. The results of the experiment are shown in FIG. 16. FIGS. 16a, 16b, 16c, and 16d show the ORP values for the tomatoes, the cucumbers, the Japanese radishes, and the carrots, respectively, measured before and after the experiment. On the right side in the photograph of each vegetable of each of the above-described graphs of FIG. 16 is shown the readout window of the ORP meter.

As shown in each of said FIGS. 16a, 16b, 16c, and 16d, the change in the ORP value for each of the vegetables was as follows. The ORP value for the tomatoes, shown in FIG. 16a changed from (+) 18 mV before immersion to (−)434 mV after immersion. The ORP value for the cucumbers, shown in FIG. 16b changed from (+)52 mV before immersion to (−)439 mV after immersion. The ORP value for the Japanese radishes, shown in FIG. 16c changed from (+) 18 mV before immersion to (−) 350 mV after immersion. The ORP value for the carrots, shown in FIG. 16d changed from (+) 204 mV before immersion to (−) 430 mV after immersion. From the above-described results, it became clear that by immersing fresh agricultural produce in the negative ion water, the ORP value of the agricultural produce was caused to be reduced by a large margin. The point to emphasize here is that even though the ORP value of the negative ion water was only (−)279 mV, the ORP values of the immersed agricultural produce fell to (−)350-439 mV, levels far lower than (−)279 mV. Therefore, it can be surmised that the reducibility (degree of freshness) of vegetables immersed in the negative ion water is raised by the effect whereby the activeness of the oxygen contained within the cells of the vegetables is promoted.

Agricultural Produce Change in Freshness Experiment 1—The next experiment was conducted to assess the change over time caused to the freshness of vegetables by immersion in the negative ion water manufactured from pure water by the negative ion liquid manufacturing apparatus according to the present invention. The Agricultural produce Change in Freshness Experiment 1 was carried out by immersing the stem of spinach purchased on the open market in the negative ion water contained in a cup, and photographing the leaves of the spinach four times: directly after the immersing; thirty minutes after the immersing; sixty minutes after the immersing; and one-hundred twenty minutes after the immersing. As a contrast group, the state of the leaves of spinach of which the stem thereof was immersed in tap water contained in a cup were photographed in the same manner. Note that the experiment was conducted maintaining stable temperature and humidity conditions.

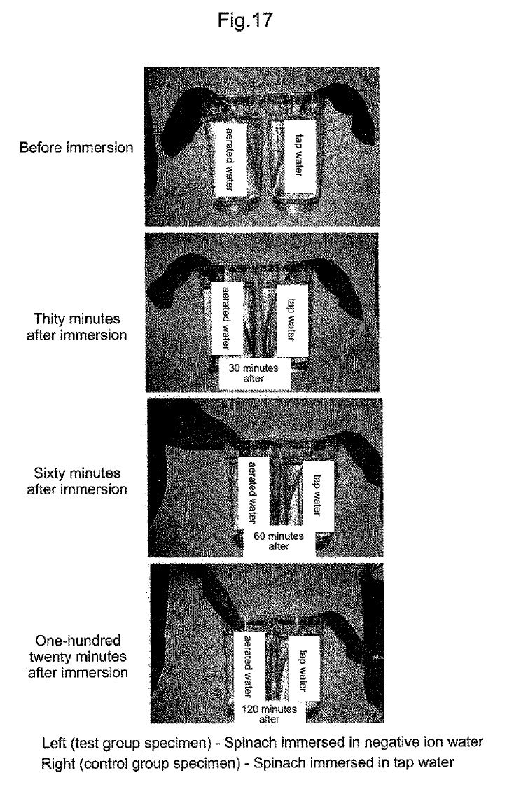

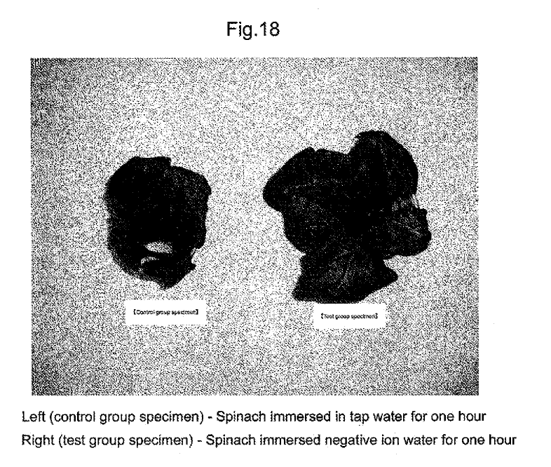

The results of the experiment are shown in FIG. 17. In each of the photographs in FIG. 17, the image on the left shows the spinach immersed in the negative ion water (the cups labeled “aerated water”), and the image on the right the spinach immersed in the tap water. As shown in FIG. 17, after the lapsing of thirty minutes from the immersing of the stem in the water, the leaves of each of the spinach plants are in a similar state; however, after sixty minutes lapses and then one-hundred twenty minutes lapses, the leaf of the spinach plant that has been immersed in the negative ion water has opened up and is extending upward, and is overall in a much more vivacious state than the leaf of spinach of which the stem thereof is immersed in the tap water. FIG. 18 shows an enlarged image of the spinach leafs after sixty minutes has lapsed from the immersing thereof in the respective types of water: the spinach leaf the stem thereof immersed in the tap water (labeled as “contrast group specimen”) is of a somewhat darkened, changed color, and is droopy; whereas the spinach leaf the stem thereof immersed in the negative ion water (labeled as “test group specimen”) is a vibrant green, vivacious, opened up and expanding. From the above-described result it is clear that by immersing agricultural produce (at least for spinach) in the negative ion water, the freshness of the produce can be maintained and even improved.

Agricultural Produce Change in Freshness Experiment 2—The next experiment was conducted to assess the change over time caused at the cellular level to the freshness of vegetables by immersion in the negative ion water manufactured from well water to which hypochlorite has been added water by the negative ion liquid manufacturing apparatus according to the present invention. The Agricultural Produce Change in Freshness Experiment 2 was carried out using a Japanese radish as the vegetable, uniformly cutting slices from a single Japanese radish purchased on the open market and immersing one slice labeled “test group” in the negative ion water for thirty minutes, and another slice labeled “contrast group” in the well water to which hypochlorite has been added (the water in the state before the negative ion water was manufactured therefrom) for thirty minutes, removing the slices from the respective water and letting said slices sit out at room temperature, examining and photographing the cells of said test group slice and said contrast group slice under a microscope after a one-day interval and a seven-day interval (place of experiment, same as the aforementioned Hokutaku Foods, Ltd., location).

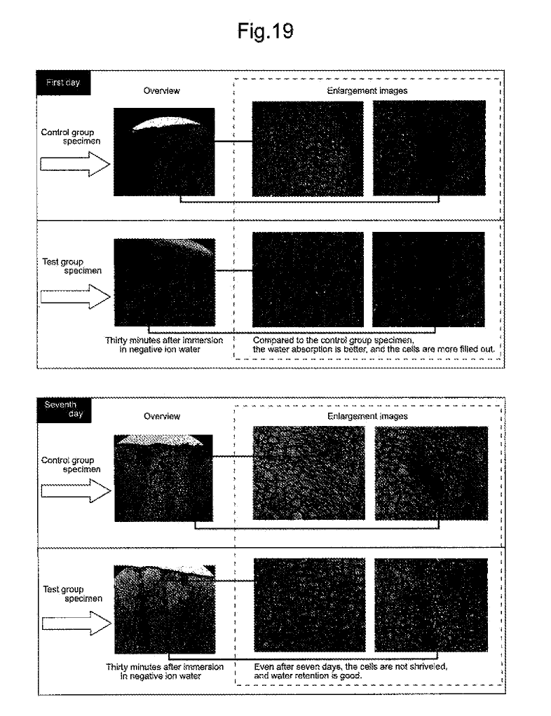

The upper portion of FIG. 19 shows the state of the cells after a one-day period after immersing, and the lower portion of FIG. 19 the state of said cells after a seven-day interval. At the one-day interval, the cells of the test group Japanese radish slice that has been immersed in the negative ion water are seen to be in a state in which the water absorption is better, the cells are larger and overall in a more vivacious state in comparison to the cells of the contrast group Japanese radish slice that has been immersed in the well water to which hypochlorite has been added (the water in the state before the negative ion water was manufactured therefrom). After the aforementioned seven-day interval, the contrast group Japanese radish cells are contracting and bent, with cell arrays in disorder; whereas the cells of the test group Japanese radish slice show no signs of contraction or bending, and the arrays thereof are maintained in order, showing an overall vivacity in comparison to the cells of the contrast group.

Note that, though not shown in the drawings, a similar experiment was conducted in which the Japanese radish slices were immersed for intervals of ten minutes and sixty minutes: after thirty minutes the cells of the Japanese radish were larger and in a more vivacious state than after ten minutes; and after sixty minutes the cells became even larger than after thirty minutes, and slightly bloated, with confirmed signs of slight disorder appearing in the cell arrays. Further, when the Japanese radish slices were cut with a knife after completion of cell observation following each immersion interval, regardless of the immersion interval, the Japanese radish slices that were immersed in the negative ion water were easier to cut and cut more cleanly compared to the contrast group Japanese radish slices.

From the above-described result it is clear that by immersing vegetables (at least Japanese radishes) in the negative ion water for only an adequate amount of time, and then removing the vegetables from the negative ion water and storing them at room temperature, the freshness of the vegetables can be maintained for a certain period of time.

The liquid manufactured according to the present invention generates a large amount of negative ions, and has an extremely low ORP value; therefore, the present invention can be used for maintaining the freshness of foodstuffs, for example, or for manufacturing drinking liquids.

1. A negative ion liquid manufacturing apparatus for obtaining a liquid which generates negative ions, comprising:
a single-stage pump provided with a casing having an inlet port for drawing in a liquid and an outlet port for discharging the liquid drawn in from the inlet port,
an impeller disposed within the casing, and
a flow channel for guiding the liquid drawn in from the inlet port to the outlet port, the right-angle cross-sectional area thereof in respect of the flow direction of the liquid flowing therethrough becoming steadily narrower progressing from the inlet port side of said flow channel toward the outlet port side of said flow channel; further compromising
a gas introducing means for sending hydrogen and oxygen into the pressurized liquid flowing through the flow channel, the pressure of the liquid flowing through said flow channel steadily increasing as said liquid flows from the inlet port side of said flow channel toward the outlet port side of said flow channel, from a point along the flow channel; wherein,
the liquid discharged from the outlet port is a liquid for generating negative ions in which hydrogen and oxygen have been dissolved therein or minute gas bubbles of hydrogen and oxygen dispersed therein.

2. A negative ion liquid manufacturing apparatus for obtaining a liquid which generates negative ions, comprising:
a single-stage pump provided with a casing having an inlet port for drawing in a liquid and an outlet port for discharging the liquid that has been drawn in from the liquid inlet port,
an impeller disposed within the casing, and
a flow channel for guiding the liquid drawn in from the inlet port to the outlet port; further comprising
a bottleneck portion having a right-angle cross-sectional area in respect of the flow direction of the pressurized liquid flowing through the flow channel that is narrower than the right-angle cross-sectional area of said flow channel,
a gas introducing means for sending hydrogen and oxygen into the pressurized liquid flowing through the flow channel from a point along said flow channel that is closer to the inlet port-side thereof than said bottleneck portion; wherein,
the liquid discharged from the outlet port is a liquid for generating negative ions in which hydrogen and oxygen have been dissolved therein or minute gas bubbles of hydrogen and oxygen dispersed therein.

3. A negative ion liquid manufacturing apparatus for obtaining a liquid a liquid which generates negative ions, comprising:
a single-stage regenerative pump provided with a casing having an inlet port for drawing in a liquid and an outlet port for discharging the liquid drawn in from the inlet port,
an impeller provided with a discoid plate having formed on the peripheral portion thereof a plurality of blades and which is disposed within the casing, and
a flow channel formed in the casing along the periphery of the impeller for guiding the liquid drawn in from the inlet port to the outlet port, the right-angle cross-sectional area thereof in respect of the flow direction of the liquid flowing therethrough becoming steadily narrower progressing from the inlet port side of said flow channel toward the outlet port side of said flow channel; further compromising
a gas introducing means for sending hydrogen and oxygen into the pressurized liquid, the pressure of the liquid flowing through said flow channel steadily increasing as said liquid flows from the inlet port side of said flow channel toward the outlet port side of said flow channel, from a point along the flow channel; wherein,
the liquid discharged from the outlet port is a liquid for generating negative ions in which hydrogen and oxygen have been dissolved therein or minute gas bubbles of hydrogen and oxygen dispersed therein.

4. A negative ion liquid manufacturing apparatus for obtaining a liquid which generates negative ions, comprising:
a single-stage centrifugal pump provided with a casing,
an impeller disposed within the casing,
an inlet port disposed on the casing for drawing in a liquid and guiding the drawn in liquid to the center portion of the impeller,
an outlet port disposed on the casing for discharging the liquid that has been drawn in from the inlet port, and
a flow channel formed spanning from a center portion of the impeller to a peripheral portion of the impeller for guiding the liquid drawn in from the inlet port to the outlet port, the right-angle cross-sectional area thereof becoming steadily narrower progressing from the center portion of the impeller toward the peripheral portion of the impeller; further comprising
a gas introducing means for sending hydrogen and oxygen into the pressurized liquid flowing through the flow channel, the pressure of the liquid flowing through said flow channel steadily increasing as said liquid flows within said flow channel from the center portion of the impeller toward the peripheral portion of the impeller; wherein,
the liquid discharged from the outlet port is a liquid for generating negative ions in which hydrogen and oxygen have been dissolved therein or minute gas bubbles of hydrogen and oxygen dispersed therein.

5. A negative ion liquid manufacturing apparatus for obtaining a liquid a liquid which generates negative ions, comprising:
a single-stage centrifugal pump provided with a casing,
an impeller disposed within the casing,
an inlet port disposed on the casing for drawing in a liquid and guiding the drawn in liquid to the center portion of the impeller,
an outlet port disposed on the casing for discharging the liquid that has been drawn in from the inlet port, and
a flow channel formed spanning from a center portion of the impeller to a peripheral portion of the impeller for guiding the flow of liquid drawn in from the inlet port to the outlet port, the right-angle cross-sectional area thereof becoming steadily narrower progressing from the center portion of the impeller toward the peripheral portion of the impeller; further comprising
ring shaped partitioning means which surround the center portion of the impeller and are formed on the surface of the interior wall of the casing so as to be in a state of non-contact with said impeller, and
a gas introducing means for sending hydrogen and oxygen into the pressurized liquid flowing through the flow channel between the partitioning means and the center portion of the impeller, wherein,
the liquid discharged from the outlet port is a liquid for generating negative ions in which hydrogen and oxygen have been dissolved therein or minute gas bubbles of hydrogen and oxygen dispersed therein.

6. A negative ion liquid manufacturing apparatus according to claim 5;
wherein, a plurality of the ring-shaped partitioning means is provided.

7. A negative ion liquid manufacturing apparatus according to any one of claims 1 through 6; further comprising
a depressurizing device for depressurizing and sending downstream the liquid that is to be discharged from the outlet port.

8. A negative ion liquid manufacturing apparatus for obtaining a liquid a liquid which generates negative ions, comprising:
a single-stage regenerative pump provided with a casing having an inlet port for drawing in a liquid and an outlet port for discharging the liquid drawn in from the inlet port,
an impeller provided with a discoid plate having formed on the peripheral portion thereof a plurality of blades and which is disposed within the casing, and
a flow channel formed in the casing along the periphery of the impeller for guiding the liquid drawn in from the inlet port to the outlet port, the right-angle cross-sectional area thereof in respect of the flow direction of the liquid flowing therethrough being of a substantially uniform dimension from the inlet port side of said flow channel toward the outlet port side of said flow channel; further compromising
a gas introducing means for sending hydrogen and oxygen into the pressurized liquid flowing through the flow channel, the pressure of the liquid flowing through said flow channel steadily increasing as said liquid flows from the inlet port side of said flow channel toward the outlet port side of said flow channel, from a point along said flow channel; wherein,
the liquid discharged from the outlet port is a liquid for generating negative ions in which hydrogen and oxygen have been dissolved therein or minute gas bubbles of hydrogen and oxygen dispersed therein.

9. A negative ion liquid manufacturing apparatus according to any one of claims 1 through 6 and claim 8; wherein,
the gas sent into the pressurized liquid flowing through the flow channel is a gas mixture of hydrogen and oxygen at a molar ratio of 2:1.

10. A negative ion liquid manufacturing apparatus according to claim 7; wherein,
the gas sent into the pressurized liquid flowing through the flow channel is a gas mixture of hydrogen and oxygen at a molar ratio of 2:1.
